(19) United States
(12) Patent Application Publication
(10) Pub. No.: US 2017/0302587 A1
(43) Pub. Date: Oct. 19, 2017

(54) METHOD FOR TRANSMITTING DATA, AND ASSOCIATED NETWORK NODE AND ASSOCIATED NETWORK

(71) Applicant: SIEMENS AKTIENGESELLSCHAFT, München (DE)

(72) Inventors: Amine Mohamed Houyou, München (DE); Hans-Peter Huth, München (DE); Vivek Kulkarni, Unterhaching (DE); Johannes Riedl, Ergolding (DE)

(21) Appl. No.: 15/513,641

(22) PCT Filed: Aug. 19, 2015
(86) PCT No.: PCT/EP2015/069087

§ 371 Date: Mar. 23, 2017

(30) Foreign Application Priority Data
Sep. 25, 2014 (DE) 10 2014 219 472.5

(51) Int. Cl. H04L 12/911; H04L 12/24; H04L 29/08

(52) U.S. Cl. CPC H04L 47/70; H04L 67/322; H04L 41/046; H04L 67/10

(57) ABSTRACT

The disclosure relates to a method for transmitting data of an application, which runs on source nodes, to a target node. Required resources are requested for the transmission in a network and the network may be subdivided into at least two virtual sub-networks and has a plurality of nodes. The method includes requesting of resources specified by a plurality of quality parameters via an application which runs on the source node, and transmitting data of the application via a virtual sub-network in which the requested resources are available.

The present patent document is a §371 nationalization of PCT Application Serial Number PCT/EP2015/069087, filed Aug. 19, 2015, designating the United States, which is hereby incorporated by reference, and this patent document also claims the benefit of DE 10 2014 219 472.5, filed Sep. 25, 2014, which is also hereby incorporated by reference.

### TECHNICAL FIELD

The disclosure relates to a method for transmitting data relating to an application, to a corresponding network node and to a corresponding network.

### BACKGROUND

In many networks, (e.g., so-called industrial networks), operation that may be predicted in terms of a time delay and reliability is necessary. Reference is made to industrial networks, in particular in fields such as industrial automation by Ethernet and IP-based networks, traffic control, machine-to-machine communication, and Supervisory Control And Data Acquisition (SCADA). Current Internet and Local Area Network (LAN) technologies cannot comply with these requirements. Therefore, new standards have been provided in the industrial field, (e.g., the Profinet standard (IEC 61784-2)), in which aspects such as time delay and reliability may be taken into account. Problems occurring here include, for example, the flexibility of existing solutions or the compatibility with conventional networks.

### SUMMARY AND DESCRIPTION

The present disclosure relates to the practice of making it possible to configure data transmission in a network in such a manner that the resources available for the transmission, in particular, are allocated efficiently and reliably.

The scope of the present disclosure is defined solely by the appended claims and is not affected to any degree by the statements within this summary. The present embodiments may obviate one or more of the drawbacks or limitations in the related art.

One aspect is to provide an existing virtual subnetwork or a virtual subnetwork to be created for data relating to an application, in which quality parameters for transmitting the data relating to the application may be complied with.

Quality parameters may be formed, in particular, from the bandwidth for a transmission, the reliability of a transmission, a permissible time delay, security, and/or importance or priority of the data to be transmitted.

According to one configuration, the disclosure also relates to a method for transmitting data relating to an application, which runs on a source node, to a target node, in which resources required for this transmission in a network are requested, and in which the network may be subdivided into at least two virtual subnetworks and has a plurality of nodes. The method includes an application running on the source node requesting resources specified by a plurality of quality parameters.

The data relating to the application are then transmitted in a corresponding virtual network in which the quality parameters may be achieved.

In order to define the virtual network, the requested resources may be mapped to a virtual subnetwork defined by the quality parameters; a check may be carried out in order to determine whether such a virtual subnetwork is already present; and, if the virtual subnetwork is present, access rights to the virtual subnetwork may be granted.

If the virtual subnetwork is not present, such a virtual subnetwork is set up and access rights to this newly setup virtual subnetwork are granted.

According to one configuration, resources that may be requested from the network, such as the bandwidth or the QoS that may be used, and the end points that may be reached are restricted. These restrictions are enforced, in particular, by a “slice” or slice mechanism (e.g., policy control), in which the available network resources are managed and virtual networks are set up, for example, and access rights to the networks are allocated.

According to another aspect, the disclosure relates to a control device that may receive a request for resources. The control device also has information relating to the network, (e.g., which nodes, which connections, etc., are available). In response to the received request, the control device allocates at least some of the resources by granting access rights to a virtual network that may be formed from at least one part of the network.

### BRIEF DESCRIPTION OF THE DRAWINGS

Further advantages are explained based on selected exemplary embodiments at least partially illustrated in the figures, in which:

FIG. 1 depicts a schematic illustration of the decoupling of the application and communication levels by inserting a management layer, according to an example.

FIGS. 2A-2C depict various illustrations of an exemplary situation in which a plurality of applications run on a terminal, namely: a) in the application view, b) in the slice view, and c) in the physical network view.

FIG. 3 depicts an example of a simplified communication service architecture.

FIG. 4 depicts a simplified exemplary embodiment of the use of a local software agent.

### DETAILED DESCRIPTION

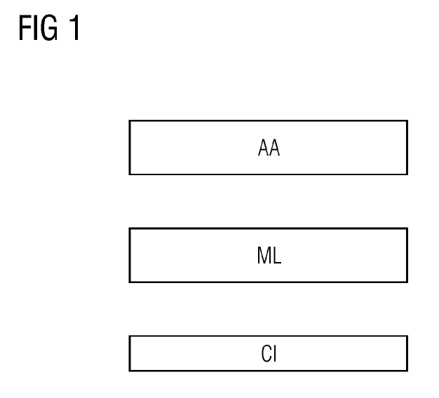

A schematic illustration of the decoupling between the automation application level and the communication infrastructure level are depicted in FIG. 1.

In order to reduce the complexity of providing communication services, it is advantageous to decouple the automation programming from the network operation itself.

This is because, for standards such as Profinet, the applications are planned in a first act, requirements are derived therefrom in a second act, and the network is accordingly planned in a third act. The network may then be implemented and configured in a fourth act before the operation of the network for the relevant applications may be started in a fifth act.

A problem is the lack of flexibility during operation if the application planning is already aimed at a particular physical network configuration and particular network operation. If something now changes in the physical network or else in one of the applications, at least some of the acts mentioned above are repeated. This is time-consuming and involves the risk of errors occurring.

The proposed decoupling, which is therefore advantageous, is effected by inserting a management layer ML that may be used to manage the available network resources or resources and to optimize their interaction. “Resource” refers to, for example, the bandwidth, possibilities for transmitting within particular times, that is to say a predefined maximum delay, or with particular quality, on particular transmission paths, etc.

This management layer ML represents an abstraction of the network resources available for the automation programming. The management layer ML is also able to provide communication services on demand or on request, (e.g., messaging services, event services, secure and reliable communication services, or reservation mechanisms for the application). Furthermore, the applications and the resources used by them are separated from one another to the greatest possible extent by this network virtualization. As a result, mutual influence is minimized and the security is increased. This management layer ML is applied to any desired network infrastructure CI. This results in the developer of the automation application seeing the network itself as the “black box” that provides various types of communication services via a defined interface.

A further problem may therefore also be eliminated: the joint operation of industrial networks, which use one technology, (e.g., Profinet), together with non-industrial technologies, (e.g., standard Internet or LAN technologies), is difficult on account of the different properties. As a result of the decoupling, it is possible to develop applications that may be shared because they are independent of the network.

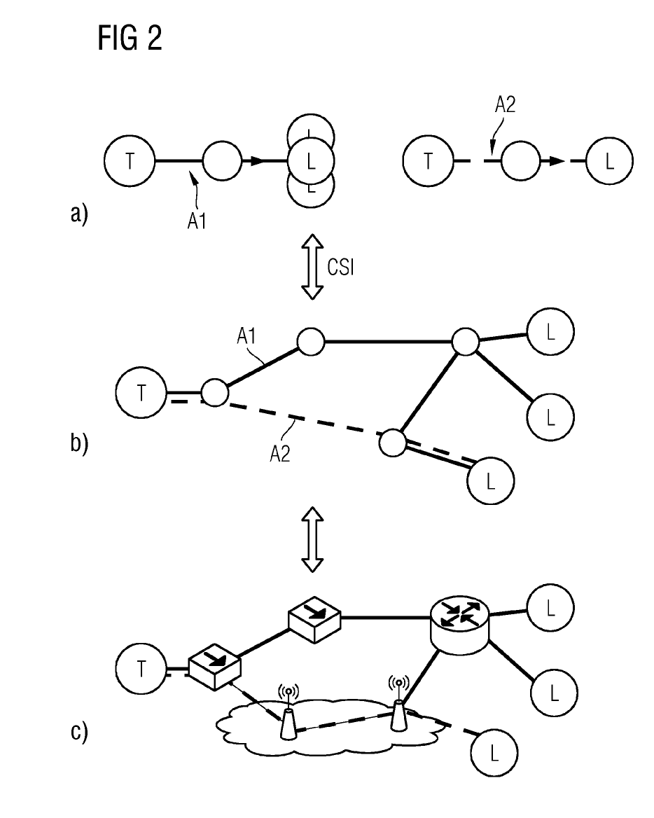

FIGS. 2A-C illustrate the situation in which a plurality of applications run on a terminal as the talker or transmitter T, from the point of view of the different levels: FIG. 2a illustrates an application view describing and/or combining applications with respect to network and communication requirements. From a superordinate viewpoint, the application view describes the applications assigned to the transmitter T, (e.g., the first application A1 and the second application A2). Their end points or destinations, (namely the receivers or listeners L, the desired quality of service (QoS), and reliability requirements), as well as further requirements, are listed. The list of these requirements is not restricted per se.

The so-called “slice view”, as illustrated in FIG. 2b, relates to the management layer SL as a virtual optimization level on which the requirements imposed by the application with regard to communication to an abstract representation of the network comprising different nodes with predefined resources and capabilities, this abstract representation of the network reflecting the actual physical topology of the network. Data relating to the application A1 and A2 are therefore transmitted, on the one hand, to different receivers L. On the other hand, during transmission to the same receiver at the bottom right, the transmission is carried out via different paths, which may correspond to a different time delay.

The slice view therefore makes it possible to design optimization criteria and formation algorithms specific to the respective field of application and in the process to take into account any different technologies or standards with their respective capabilities. Optimization may take place in a software function in the form of a “slice manager”. The connection between the application representation and the slice representation may be established via a communication service interface CSI, (e.g., a local software agent), because the requirements of an application are associated with the network conditions thereby.

The physical network view, illustrated in FIG. 2c and relating to the network infrastructure level CI, includes the functionality needed to capture both network-dynamic aspects, (e.g., capture of nodes, state of a connection, network topology and offered features and resources), and the signaling and so-called “slice mapping decisions” made on the level above.

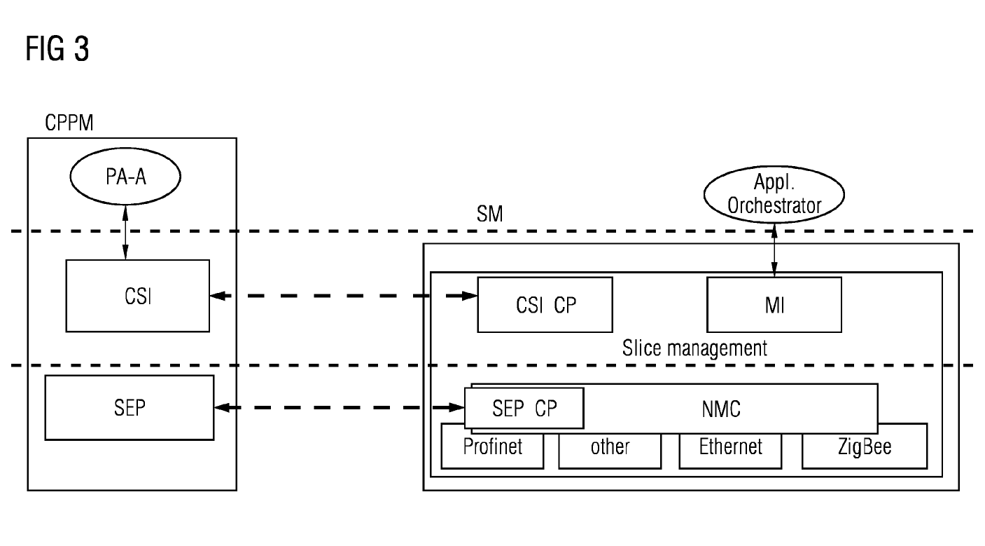

In FIG. 3, a controllable production module or “Cyber Physical Production Module” CPPM, which is suitable for cooperation with other elements, is schematically broken down into the levels illustrated in FIG. 1.

Application requirements with respect to the network are defined in a negotiation phase between two or more production modules CPPM. This “negotiation” is part of a so-called “plug & automate” process that defines the manner in which the application runs and the communication between two or more production modules CPPM.

For example, the speed of a production module CPPM in the form of a conveyor belt is configured to the gripping movement of a further production module in the form of a gripping robot. Communication or data interchange between these two production modules is necessary for this purpose and runs via this application.

Depending on the type of application, particular requirements are imposed on communication with one or more further production modules. For example, a video transmission application for a conveyor belt section might require a relatively wide bandwidth, whereas lower requirements are imposed on a time delay, (e.g., a delay during transmission). Security requirements, (e.g., precautions against bugging or manipulation by others), may also be kept lower here. Cutbacks may also be made here with regard to the reliability of the transmission if the video transmission is not primarily important for the production itself.

The situation may be different if a control command is transmitted, via a first production module CPPM, to a robot as a further production module, (e.g., stating that the robot would have to act exactly at a predefined time), because otherwise the workpiece would be damaged. In this case, only an extremely short time delay would be acceptable and manipulations may be prevented, whereas the required bandwidth is lower. In contrast, high demands may be imposed on the reliability of the transmission because faults may be produced in the workpiece if the control command is lost.

It is clear from these examples that, depending on the specific application, particular resources subject to particular quality parameters are required for the transmission. These quality parameters include, in particular, the bandwidth, time delay, the reliability of the transmission, security against interventions by others, and security against tapping by others and other manipulations. All of the quality parameters for a particular transmission are often also referred to as a service level agreement or SLA.

The requirements or quality parameters are given to the management layer or level ML by the application level. For this purpose, the communication service interface CSI is on the level of the management layer ML. This communication service interface acts as a “translator” of the requirements coming from the application level, in which case the translation is carried out in such a manner that the communication infrastructure level CI below may use these requirements. The actual boundary conditions of the communication infrastructure level CI therefore need not be known on the application level AA. The communication service interface CSI is provided with a “command set” that depends on the communication infrastructure level CI.

The communication infrastructure level CI contains a so-called “slice enforcement point” (SEP) or slice implementation point or point for setting up virtual networks.

In FIG. 3, elements framed with rectangles represent signal, control, and enforcement functions. Elements framed with an ellipse represent an application that issues particular requests. For example, the plug & automate application PA-A passes a request with respect to the required transmission resources to the communication service interface CSI on the management level below.

A local communication service interface CSI acting as a local software agent, for example, is provided on each terminal supporting slicing of the network or is “slice enabled”. In this case, a terminal may be a production module CPPM, in particular.

The production module CPPM may itself act as a network node or may have a communication interface to a network node.

This local communication service interface CSI allows a limited selection of possible commands that may be regulated, for example, by security guidelines or decisions made by an operator or/and of boundary conditions of the underlying physical network infrastructure.

The local communication service interface CSI may use the local slice enforcement point SEP as an entry point. There is no direct connection between the communication service interface CSI and the slice manager provided on the automation application level AA.

The local communication service interface CSI is additionally responsible for carrying out local configurations required under certain circumstances but are independent of the subdivision into virtual subnetworks or slices themselves, e.g., the management of the local access control.

In addition to the local communication service interface CSI, which is an integral part of the production module CPPM, a management interface MI is provided for the operator of the network, which management interface supports the subdivision into slices or virtual subnetworks, that is to say may be part of a management panel and may have a system-wide configuration and an interface to planning tools.

The slice enforcement point SEP is a logical function that manages network interfaces of terminals, in particular, production modules, switches, routers, or other network devices. The slice enforcement point SEP is used to implement the actual configuration of the relevant interfaces and devices. A slice enforcement point SEP may be an agent on this device or a local controller. Alternatively, or additionally, the slice enforcement point SEP may be implemented by software algorithms in the “slice manager” SM that uses a non-local or remote configuration interface, (e.g., according to the SNMP (Simple Network Management Protocol, IETF RFC 3410) Internet standard or other management standards).

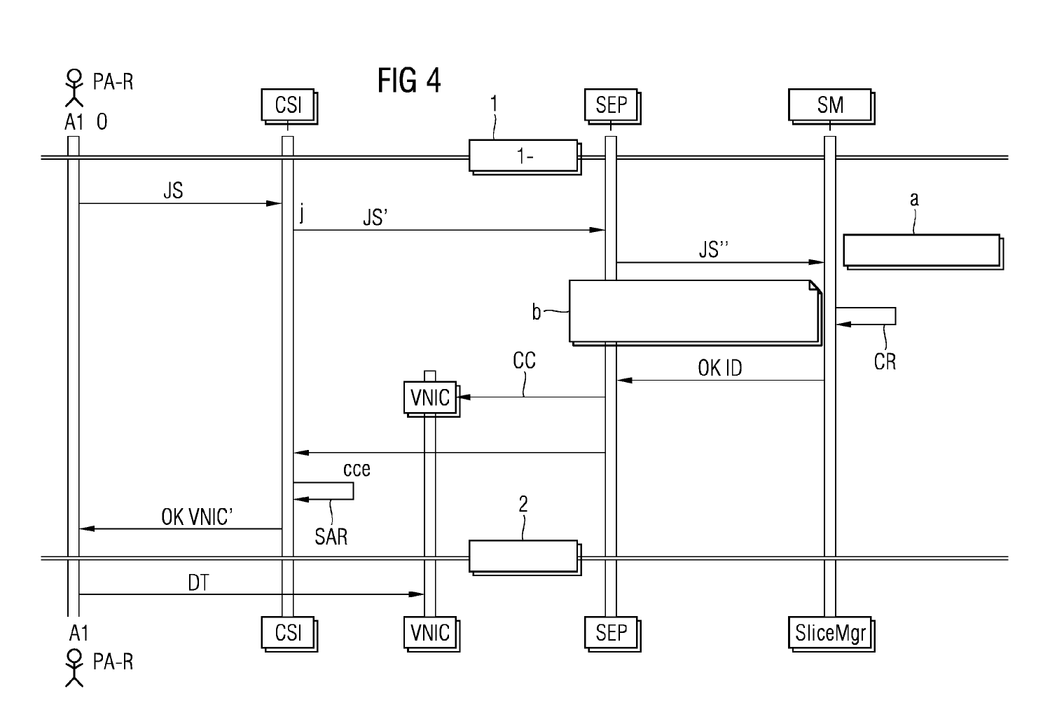

The slice manager SM or manager for virtual networks is illustrated as being separate from the production module in the exemplary embodiment in FIG. 4. The slice manager may be implemented in the production module CPPM or as a unit separate from the latter and has interfaces. In the case of separation, corresponding pendants or counterparts for the slice enforcement point SEP, namely the SEP counterpart SEP-CP, and the communication service interface CSI, namely the CSI counterpart CSICP, are provided in the slice manager.

In the exemplary embodiment depicted in FIG. 3, the SEP counterpart SEP-CP is part of network management and control NMC for one or more of the networks provided, (e.g., Profinet, Ethernet, ZigBee, or others). If an object-oriented abstraction layer is used in the network management and control NMC, these different technologies may be combined under one roof, that is to say the management may be carried out equally for all irrespective of the respective technology.

The management interface MI of the slice manager SM interchanges data with an application coordination point AO or application configuration server that coordinates which applications may actually run under the predefined physical boundary conditions, for example, such that the total bandwidth of the system is not exceeded. The application coordination point AO may be a network interface controller or NIC, in particular.

FIG. 4 schematically illustrates the use of the communication service interface CSI.

In a first section 1, a slice or a virtual subnetwork is first of all set up. This makes it possible to eliminate the problem of many applications of different production modules competing for the available resources and having to be shielded from one another for security and management reasons. Furthermore, parameters such as quality of service (QoS), reliability and the transmission path may be reliably managed by setting up a virtual network. In the first section, the requirement a) is therefore forwarded. Furthermore, b) access rights are checked and—if it does not yet exist—a virtual subnetwork is set up and is configured according to the requirements.

In a second section 2, the actual data transmission DT is carried out for the relevant application that requires precisely a particular quality of service.

A plug & automate requestor PA-R, which may be a particular application, for example, would like to join a slice or virtual network, that is to say it requests a transmission with certain quality features by a join request JS.

The communication service interface CSI passes the possibly reworded “join request” JS' to the slice enforcement point SEP. This transmission is therefore carried out indirectly by using the communication service interface CSI.

The slice enforcement point SEP in turn checks the request and forwards it to the slice manager SM. The latter checks the request in the act CR and accepts the request in the act OK ID in the illustrated example and sends a slice identifier back to the slice enforcement point SEP. The latter generates and configures a virtual network interface VNIC in the act CC and sends a confirmation with the name of the virtual interface back to the communication service interface CSI in the act OK VNIC. Furthermore, the SEP sets the local access rights in the act SAR and sends a confirmation of the name of the virtual interface back to the plug & automate requestor PA-R in the act OK VNIC′.

If necessary, the slice manager SM also configures the network in such a manner that a new virtual network or slice, which provides the resources with the stated quality conditions, is created.

If such a virtual network is already present, it is provided that participation in said network is possible.

In other words, the slice enforcement point SEP may create a local slice end point that is substantially a layer 2 interface associated with quality requirements and other network regulations. The local identifier of this new interface is passed back to the application via the communication service interface CSI. After this act, the data transmission of the application may use the new slice interface.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for transmitting data relating to an application, the method comprising:
requesting, by the application running on a source node within a network, resources specified by a plurality of quality parameters, wherein the network is configured to be subdivided into at least two virtual subnetworks having a plurality of nodes; and
transmitting, to a target node, the data relating to the application via a virtual subnetwork of the at least two virtual subnetworks in which the requested resources are available.

2. The method of claim 1, further comprising:
granting access rights to the virtual subnetwork.

3. The method of claim 1, further comprising, when the virtual subnetwork does not yet exist:
setting up the virtual subnetwork prior to the transmitting of the data.

4. The method of claim 1, wherein the virtual subnetwork is defined by the plurality of quality parameters.

5. The method of claim 1, wherein a quality parameter of the plurality of quality parameters is formed by variables selected from the group consisting of: bandwidth, reliability time delay, security, importance, or a combination thereof.

6. The method of claim 1, wherein the resources of the network are configured to be restricted.

7. The method of claim 1, wherein the application requests the resources via a management layer,
wherein information relating to physically available resources are present in the management layer, and
wherein the request is reworded in the management layer taking into account the information relating to the physically available resources.

8. The method of claim 7, further comprising:
forwarding the reworded request to a network infrastructure layer; and
locally deciding whether the reworded request is forwarded to a network interface controller.

9. The method of claim 8, wherein the local decision is made in an entity for setting up virtual networks.

10. The method of claim 1, further comprising:
transmitting, by a network interface controller, a response to a network infrastructure layer; and
establishing, in event of a positive response, an interface to the virtual subnetwork, wherein the interface is used to transmit the data relating to the application.

11. A network node comprising:
an application configured to request resources specified by a plurality of quality parameters, the application running on the network node within a network, wherein the network is configured to be subdivided into at least two virtual subnetworks having a plurality of nodes,
wherein the network node is configured to transmit to a target node data relating to the application via a virtual subnetwork of the at least two virtual subnetworks in which the requested resources are available.

12. The network node of claim 11, wherein the network node is configured to transmit data relating to the application to at least one further network node,
wherein the network node is configured to receive a request message from the application, wherein the request message is used to request transmission resources, and
wherein the network node is configured to transmit messages to a network interface controller or receive messages from the network interface controller, wherein the messages are used to control incorporation into an existing virtual network or/and to control the setting-up of a new virtual network based on specifications in the request message.

13. The network node of claim 11, wherein the network node is a production module or has an interface to the production module,
wherein the network node comprises a computing unit having:
at least one application for a function of the production module or a cooperation of the production module with further modules configured to be carried out;
a software agent responsible for the local configuration, wherein the software agent has available a predefined set of configuration command, and is configured to receive a request from an application with regard to transmission resources required for the application; and
a point for setting up virtual networks, wherein the point is configured to communicate with a manager for virtual networks and a network interface controller.

14. A network comprising:
at least two network nodes configured to be subdivided into one or more virtual subnetworks, wherein a network node of the at least two network nodes comprises an application configured to request resources specified by a plurality of quality parameters, wherein the network node is configured to transmit to a target node data relating to the application via a virtual subnetwork of the at least two virtual subnetworks in which the requested resources are available; and
a network interface controller for setting up, managing, or setting up and managing the virtual subnetworks.

15. A controller for managing resources for a data transmission, which are available in a network and are at least partially provided for transmitting data from an application, the controller being configured to:
receive a request from an application with regard to a resource for the transmission in a network;
obtain information relating to the network; and
reserve a portion of the available resources for the application.

16. A computer program product having program instructions configured to:
request, by the computer program product running on a source node within a network, resources specified by a plurality of quality parameters, wherein the network is configured to be subdivided into at least two virtual subnetworks having a plurality of nodes; and
transmit, to a target node, the data relating to the computer program product via a virtual subnetwork of the at least two virtual subnetworks in which the requested resources are available.
